(19) United States
(12) Patent Application Publication
(10) Pub. No.: US 2026/0148897 A1
(43) Pub. Date: May 28, 2026

(54) MULTILAYER ELECTRONIC COMPONENT

(71) Applicant: SAMSUNG ELECTRO-MECHANICS CO., LTD., Suwon-si (KR)

(72) Inventors: Jin Sung Chun, Suwon-si (KR); Kyeong Jun Kim, Suwon-si (KR); Min Suk Kim, Suwon-si (KR); Wi Hun Kim, Suwon-si (KR)

(73) Assignee: SAMSUNG ELECTRO-MECHANICS CO., LTD., Suwon-si (KR)

(21) Appl. No.: 19/264,547

(22) Filed: Jul. 9, 2025

(30) Foreign Application Priority Data
Nov. 27, 2024 (KR) 10-2024-0172375

(51) Int. Cl. H01G 4/12; H01G 4/30

(52) U.S. Cl. CPC H01G 4/1227; H01G 4/30

(57) ABSTRACT

A multilayer electronic component includes a body including dielectric layers and internal electrodes alternately disposed with at least one of the dielectric layers in a first direction, and an external electrode disposed on the body and connected to at least one of the internal electrodes, wherein at least one of the dielectric layers includes a perovskite layer including a first grain not having a core-shell structure and a perovskite compound represented by a general formula ABO₃, and an auxiliary layer disposed on both surfaces of the perovskite layer opposing each other in the first direction and including a first additive element, wherein the first additive element may include one or more of Dy, Ho, Y, Er, Gd, Tb, Mg, Mn, V, Al, and Si.

### CROSS-REFERENCE TO RELATED APPLICATION(S)

This application claims benefit of priority to Korean Patent Application No. 10-2024-0172375 filed on Nov. 27, 2024 in the Korean Intellectual Property Office, the disclosure of which is incorporated herein by reference in its entirety.

### TECHNICAL FIELD

The present disclosure relates to a multilayer electronic component.

A multilayer ceramic capacitor (MLCC), a multilayer electronic component, is a chip-type condenser, mounted on the printed circuit boards of various types of electronic products, such as image display devices including a liquid crystal display LCD and a plasma display panel PDP, computers, smartphones and mobile phones, and serves to charge or discharge electricity therein or therefrom. These multilayer ceramic capacitors may be used as a component in various electronic devices due to having a small size, ensuring high capacitance and being easily mounted.

As the usage environments of multilayer ceramic capacitors have become increasingly harsh, research has been conducted to improve the temperature stability and reliability of multilayer ceramic capacitors. In particular, a method of forming a dielectric layer by adding various subcomponent elements, such as rare earth elements, to a BaTiO₃-based perovskite compound used as a main component to improve the reliability of multilayer ceramic capacitors is being used. In this case, dielectric grains constituting the dielectric layer form a core-shell structure, and as the dielectric grains have the core-shell structure, room temperature permittivity, withstand voltage characteristics, and lifespan reliability may be improved, as compared to pure BaTiO₃-based perovskite compounds.

However, when the dielectric layer is manufactured using a dielectric composition in which a BaTiO₃-based main component powder and a subcomponent powder are mixed to form dielectric grains having the core-shell structure, the core-shell structure may be formed randomly. In this case, there is a limitation in that the size or position of the core implementing capacitance may not be controlled, and if a fraction of the core within an entire grain decreases, a problem may occur in which capacitance of the multilayer ceramic capacitor decreases. Accordingly, research is required for a new type of dielectric layer that may replace the dielectric layer having the existing core-shell structure grains.

### SUMMARY

An aspect of the present disclosure is to provide a multilayer electronic component having excellent capacity and reliability.

However, problems to be solved by the present disclosure are not limited to the above, and will be more easily understood in the process of describing specific embodiments of the present disclosure.

A multilayer electronic component according to an embodiment of the present disclosure may comprise: a body including dielectric layers and internal electrodes alternately disposed with at least one of the dielectric layers in a first direction, and an external electrode disposed on the body and connected to at least one of the internal electrodes, wherein the at least one of the dielectric layers may include a perovskite layer including a first grain free of a core-shell structure and a perovskite compound represented by the general formula ABO₃, and an auxiliary layer disposed on both surfaces of the perovskite layer opposing in the first direction and including a first additive element, and wherein the first additive element may include one or more selected from Dy, Ho, Y, Er, Gd, Tb, Mg, Mn, V, Al, and Si.

A multilayer electronic component according to the embodiment of the present disclosure may comprise: a body including dielectric layers and internal electrodes alternately disposed with at least one of the dielectric layer in the first direction, and external electrodes disposed on the body and connected to at least one of the internal electrodes, wherein at least one of the dielectric layers may include a single-crystal perovskite layer including a perovskite compound represented by a general formula ABO₃, and the auxiliary layer disposed on both surfaces of the single-crystal perovskite layer opposing in the first direction and including the first additive element.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a perspective view schematically illustrating a multilayer electronic component according to an embodiment of the present disclosure.

FIG. 2 schematically illustrates a cross-sectional view taken along line I-I′ of FIG. 1.

FIG. 3 schematically illustrates a cross-sectional view taken along line II-II′ of FIG. 1.

FIG. 4 is a cross-sectional view schematically illustrating a microstructure of a dielectric layer.

FIGS. 5 to 8 are cross-sectional views schematically illustrating the microstructure of the dielectric layer of a multilayer electronic component according to another embodiment of the present disclosure.

FIGS. 9A and 9B are each a drawing illustrating capacitance of comparative examples and embodiments, respectively, measured using a COMSOL analysis program.

### DETAILED DESCRIPTION

Hereinafter, embodiments of the present disclosure will be described with reference to specific embodiments and the accompanying drawings. However, embodiments of the present disclosure may be modified into various other forms, and the scope of the present disclosure is not limited to the embodiments described below. Further, embodiments of the present disclosure may be provided for a more complete description of the present disclosure to the ordinary artisan. Therefore, shapes and sizes of the elements in the drawings may be exaggerated for clarity of description, and the elements denoted by the same reference numerals in the drawings may be the same elements.

In the drawings, portions not related to the description will be omitted for clarification of the present disclosure, and a thickness may be enlarged to clearly illustrate layers and regions. The same reference numerals will be used to designate the same components in the same reference numerals. Further, throughout the specification, when an element is referred to as “comprising” or “including” an element, it means that the element may further include other elements as well, without departing from the other elements, unless specifically stated otherwise.

In the drawing, a first direction X may be defined as a thickness T direction, a second direction Y may be defined as a length L direction, and a third direction Z may be defined as a width W direction.

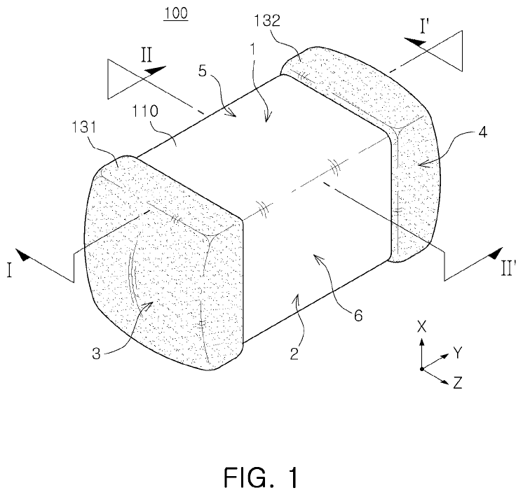

FIG. 1 is a perspective view schematically illustrating a multilayer electronic component according to an embodiment of the present disclosure.

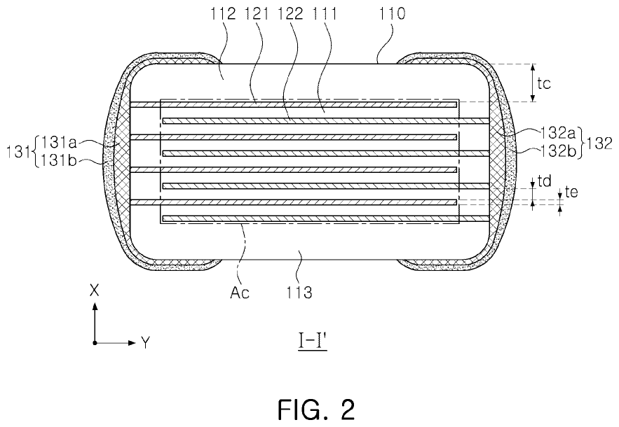

FIG. 2 schematically illustrates a cross-sectional view taken along line I-I′ of FIG. 1.

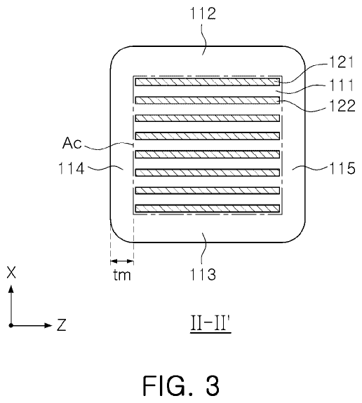

FIG. 3 schematically illustrates a cross-sectional view taken along line II-II′ of FIG. 1.

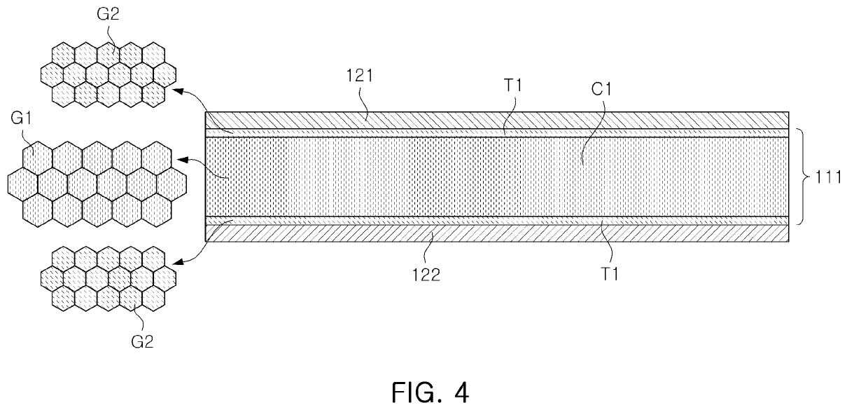

FIG. 4 is a cross-sectional view schematically illustrating a microstructure of a dielectric layer.

Hereinafter, a multilayer electronic component 100 according to an embodiment of the present disclosure will be described in detail with reference to FIGS. 1 to 6. In addition, as an example of a multilayer electronic component, a multilayer ceramic capacitor is described, but the present disclosure is not limited thereto and may also be applied to various multilayer electronic components, such as inductors, piezoelectric elements, varistors, or thermistors.

A multilayer electronic component 100 according to an embodiment of the present disclosure may include a body 110 including a dielectric layer 111 and internal electrodes 121 and 122, and external electrodes 131 and 132.

There is no particular limitation on the specific shape of the body 110, but as illustrated, the body 110 may have a hexahedral shape or a shape similar thereto. Due to shrinkage of ceramic powder particles included in the body 110 during a sintering process or due to the polishing process for corner portions of the body 110, the body 110 may not have a hexahedral shape with entirely straight lines, but may have a substantially hexahedral shape.

The body 110 may have first and second surfaces 1 and 2 opposing each other in the first direction, third and fourth surfaces 3 and 4 connected to the first and second surfaces 1 and 2 and opposing each other in the second direction, and fifth and sixth surfaces 5 and 6 connected to the first to fourth surfaces 1, 2, 3, and 4 and opposing each other in the third direction.

A plurality of dielectric layers 111 are in a sintered state, such that boundaries between adjacent dielectric layers 111 may be integrated so as to be difficult to identify without using a scanning electron microscope (SEM).

The internal electrodes 121 and 122 may be disposed alternately in the first direction with the dielectric layer 111. The body 110 may include a capacitance formation portion Ac forming capacitance, including a first internal electrode 121 and a second internal electrode 122 disposed opposing each other with a dielectric layer 111 therebetween.

The first internal electrode 121 may be spaced apart from the fourth surface 4 and connected to a first external electrode 131 on the third surface 3. The second internal electrode 122 may be spaced apart from the third surface 3 and connected to a second external electrode 132 on the fourth surface 4.

A conductive metal included in the internal electrodes 121 and 122 may be one or more of Ni, Cu, Pd, Ag, Au, Pt, Sn, W, Ti, and alloys thereof, but the present disclosure is not limited thereto.

At least one of the plurality of dielectric layers 111 may include a perovskite layer C1 and an auxiliary layer T1 disposed on both surfaces of the perovskite layer C1 opposing in the first direction. For example, the auxiliary layer T1 may be disposed between the perovskite layer C1 and the internal electrodes 121 and 122.

The perovskite layer C1 may have a first crystal grain G1 including a perovskite compound represented by the general formula ABO₃. For example, the perovskite layer C1 may include the perovskite compound as a main component, and the first crystal grain G1 included in the perovskite layer C1 may have a perovskite crystal structure. The perovskite layer C1 may have, for example, a polycrystalline structure of the first grain G1. The perovskite layer C1 may have, for example, a thin-film structure formed of a perovskite compound.

The perovskite compound may include, for example, one or more of BaTiO₃, (Ba₁₋ₓCaₓ)TiO₃ (0<x<1), Ba(Ti_{1-y}Ca_{y})O₃ (0<y<1), (Ba₁₋ₓCaₓ)(Ti_{1-y}Zr_{y})O₃ (0<x<1, 0<y<1), Ba(Ti_{1-y}Zr_{y})O₃ (0<y<1), CaZrO₃, and (Ca₁₋ₓSrₓ)(Zr_{1-y}Ti_{y})O₃ (0<x≤0.5, 0<y≤0.5).

The auxiliary layer T1 may include the first additive element. For example, the auxiliary layer T1 may include the first additive element as a main component. The first additive element may include, for example, one or more of a rare earth element, a fixed valence acceptor element, a variable valence acceptor element, and a sintering aid element. That is, the first additive element may generally refer to a subcomponent added to ABO₃ which is a main component. The first additive element may include one or more of Dy, Ho, Y, Er, Gd, Tb, Mg, Mn, V, Al, and Si.

Meanwhile, in the present disclosure, the “main component” may refer to a component occupying a relatively large weight ratio or atomic number ratio compared to other components, and may refer to a component exceeding 50 wt % based on the weight of an entire composition or the entire dielectric layer, a component exceeding 50 at % based on the number of atoms, or a component exceeding 50 mol % based on the number of moles.

The first grain G1 included in the perovskite layer C1 may be free of a core-shell structure. The first grain G1 included in the perovskite layer C1 may not have a core-shell structure. In the present disclosure, the fact that the grains forming the dielectric layer 111 have a “core-shell structure”, may mean the grains have a core portion not containing the first additive element or having a relatively low concentration of the first additive element and a shell portion having a relatively high concentration of the first additive element.

That is, the fact that the first grain G1 does not have a core-shell structure, may mean the first grain G1 may not have two phases with different concentrations of the first additive element, but has a single phase.

When a dielectric layer is formed using a dielectric composition in which a perovskite-based main component powder and an additive powder are mixed to form dielectric grains having a core-shell structure, the core-shell structure may be formed randomly.

This may cause problems such as a reduction in capacitance of a multilayer electronic component due to inability to control a size or location of the core implementing capacitance.

However, the multilayer electronic component 100 according to an embodiment of the present disclosure may effectively improve the capacitance of the multilayer electronic component 100 by including the first grain G1 in which the perovskite layer C1 does not have a core-shell structure.

The crystal grain G1 may, for example, substantially not contain the first additive element.

In the present disclosure, the fact that the first grain G1 substantially does not include the first additive element, may mean the first additive element is not intentionally added to the perovskite layer C1 to improve the capacitance of the multilayer electronic component 100. However, during a manufacturing process of the multilayer electronic component 100, a very small portion of the first additive element may unexpectedly exist in the perovskite layer C1. Even in this case, when the first grain G1 does not have a core-shell structure, the capacitance of the multilayer electronic component 100 may be improved. That is, the fact that the first grain G1 substantially does not include the first additive element, may mean a content of the first additive element among a total content of elements constituting the first grain G1 is 0.01 at % or less.

Meanwhile, when the first grain G1 does not have the core-shell structure, there is a concern that the room temperature permittivity, withstand voltage characteristics, and life reliability of the multilayer electronic component 100 may deteriorate but the dielectric layer 111 of the multilayer electronic component 100 according to an embodiment of the present disclosure may secure a reliability of the multilayer electronic component 100 by including the auxiliary layer T1 including the first additive element.

Meanwhile, the perovskite layer C1 and the auxiliary layer T1 may be formed separately. The auxiliary layer T1 may have a polycrystalline structure of a second grain G2, and the second grain G2 may not have a perovskite crystal structure because it contains the first additive element as its main component. That is, the second grain G2 may have a different crystal structure from the first grain G1. An average grain size of the first grain G1 may be greater than an average grain size of the second grain G2, but the present disclosure is not limited thereto.

The auxiliary layer T1 may include a second additive element including at least one of Ba, Ti, Ca, and Zr in addition to the first additive element. The auxiliary layer T1 may more effectively improve a reliability of the multilayer electronic component 100 by including the second additive element.

The perovskite layer C1 may include, for example, a plurality of the first grains G1 disposed continuously in a direction perpendicular to the first direction. However, not all grains disposed in the perovskite layer C1 must be first grains G1 not having a core-shell structure. For example, the perovskite layer C1 may also include portion of grains having a core-shell structure.

Even in this case, in order to prevent the capacitance of the multilayer electronic component from being reduced, a ratio of the number of first grains G1 to the total number of grains disposed in the perovskite layer C1 may be, for example, 80% or more. The number ratio of the first grain G1 may specify a certain region in an image analyzed by an analysis device such as STEM-EDS of an arbitrary cross-section of the dielectric layer 111 and may be calculated from the total number of grains and the number of the first grains G1 existing in the certain region. The total number of grains extracted from the certain region may be, for example, 10 to 200, but the present disclosure is not limited thereto.

A thickness of the perovskite layer C1 and the auxiliary layer T1 is not particularly limited. That is, the thickness of the perovskite layer C1 and the auxiliary layer T1 may be appropriately designed in consideration of the specifications or performance of the multilayer electronic component 100. For example, as illustrated in FIG. 4, in order to increase the capacitance of the multilayer electronic component 100, the thickness of the perovskite layer C1 may be greater than the thickness of the auxiliary layer T1. The thicknesses of the perovskite layer C1 and the auxiliary layer T1 may be measured by STEM. Other methods and/or tools appreciated by one of ordinary skill in the art, even if not described in the present disclosure, may also be used.

The body 110 may include cover portions 112 and 113 disposed on both surfaces of the capacitance formation portion Ac opposing each other in the first direction. The body 110 may include margin portions 114 and 115 disposed on both surfaces of the capacitance formation portion Ac opposing each other in the third direction. The cover portions 112 and 113 and the margin portions 114 and 115 may contain the perovskite compound as a main component. The cover portions 112 and 113 and the margin portions 114 and 115 may have the same configuration as the dielectric layer 111 or may have a different configuration from the dielectric layer 111.

External electrodes 131, 132 may be disposed on the third and fourth surfaces 3 and 4 of the body 110 and may be extended onto a portion of the first, second, fifth and sixth faces 1, 2, 5, and 6. The external electrodes 131 and 132 may include the first external electrode 131 connected to the first internal electrode 121 and the second external electrode 132 connected to the second internal electrode 122.

Types or shapes of the external electrodes 131 and 132 may not be particularly limited, and may have a multilayer structure. For example, the external electrodes 131 and 132 may include base electrode layers 131a and 132a in contact with the internal electrodes 121 and 122 and plating layers 131b and 132b disposed on the base electrode layers 131a and 132a.

The base electrode layers 131a and 132a may be sintered electrode layers including metal and glass. The metal included in the base electrode layers 131a and 132a may include, for example, Cu, Ni, Pd, Pt, Au, Ag, Pb, and/or alloys thereof. The glass included in the base electrode layers 131a and 132a may include, for example, one or more oxides of Ba, Ca, Zn, Al, B, and Si.

Meanwhile, the base electrode layers 131a and 132a may be configured by only the sintered electrode layer, but the present disclosure may not be limited thereto, and the base electrode layers 131a, 132a may include a sintered electrode layer including metal and glass, and a resin electrode layer disposed on the sintered electrode layer and including metal particles and resin.

The metal particles included in the resin electrode layer may include one or more of spherical particles and flake-shaped particles. The metal particles included in the resin electrode layer may include, for example, Cu, Ni, Pd, Pt, Au, Ag, Pb, Sn and/or alloys thereof. The resin included in the resin electrode layer may include, for example, one or more of epoxy resin, acrylic resin, and ethyl cellulose.

The plating layers 131b, 132b may include, for example, Ni, Sn, Pd and/or alloys thereof, and may be formed of a plurality of layers. The plating layers 131b and 132b may be, for example, Ni plating layer or Sn plating layer, and may also be in the form in which the Ni plating layer and the Sn plating layer are formed sequentially thereon. The plating layers 131b and 132b may include a plurality of Ni plating layers and/or a plurality of Sn plating layers.

Although the drawing describes a structure in which a multilayer electronic component 100 has two external electrodes 131 and 132, it may not be limited thereto, and the number or shape of the external electrodes 131 and 132 may be changed depending on the shape of the internal electrodes 121 and 122 or other purposes.

An average thickness td of the dielectric layer 111, an average thickness te of the internal electrodes 121 and 122, an average thickness tc of the cover portions 112 and 113, and an average thickness tm of the margin portions 114 and 115 are not particularly limited.

The average thickness td of the dielectric layer 111 may be, for example, 0.01 μm to 10 μm, 0.01 μm to 5 μm, 0.01 μm to 2 μm, or 0.01 μm to 0.4 μm. The average thickness te of the internal electrodes 121 and 122 may be, for example, 0.01 μm to 3.0 μm, 0.01 μm to 1.0 μm, or 0.01 μm to 0.4 μm.

The average thickness tc of the cover portions 112 and 113 may be, for example, 150 μm or less, 100 μm or less, 30 μm or less, or 20 μm or less. The average thickness of the cover portions 112 and 113 may be, for example, 5 μm or more, 10 μm or more, or 30 μm or more. In this case, the average thicknesses tc of the cover portions 112 and 113 may refer to an average thickness of each of a first cover portion 112 and a second cover portion 113.

The average thickness tm of the margin portions 114 and 115 may be, for example, 100 μm or less, 20 μm or less, or 15 μm or less. The average thickness of the margin portions 114 and 115 may be, for example, 5 μm or more, or 10 μm or more. In this case, the average thickness tm of the margin portion 114 and 115 may refer to an average thickness of each of a first margin portion 114 and a second margin portion 115.

A size of the multilayer electronic component 100 is not particularly limited, but a maximum length of the multilayer electronic component 100 in the second direction may be 0.1 mm to 6.0 mm, a maximum width of the multilayer electronic component 100 in the third direction may be 0.1 mm to 5.0 mm, and a maximum thickness of the multilayer electronic component 100 in the first direction may be 0.05 mm to 3.5 mm.

The average thickness td of the dielectric layer 111 and the average thickness te of the internal electrodes 121 and 122 may be measured by scanning a cross-section of the multilayer electronic component 100 in the first and second direction with a scanning electron microscope SEM of 10,000× magnification. More specifically, the average thickness td of the dielectric layer 111 may be measured by calculating the average after measuring the thickness at a plurality of points of one dielectric layer 111, for example, at five points equally spaced apart from each other in the second direction, and then taking the average value. In addition, the average thicknesses te of the internal electrodes 121 and 122 may be measured by calculating the average after measuring the thicknesses at a plurality of points of one internal electrode, for example, at five points equally spaced apart from each other in the second direction. The five points equally spaced apart from each other may be designated in the capacitance formation portion Ac. Meanwhile, when the average value measurements are performed for each of 10 dielectric layers 111 and 10 internal electrodes 121 and 122, and then the average values are calculated, the average thickness td of the dielectric layer 111 and the average thicknesses te of the internal electrodes 121 and 122 may be further generalized.

Similarly, the average thickness tc of the cover portions 112 and 113 may be an average value of the thickness measured at five points equally spaced apart from a cross-section of the multilayer electronic component 100 in the first and second direction. The average thickness tm of the margin portions 114 and 115 may be an average value of the thickness measured at five points equally spaced apart from a cross-section of the multilayer electronic component 100 in the first and third direction.

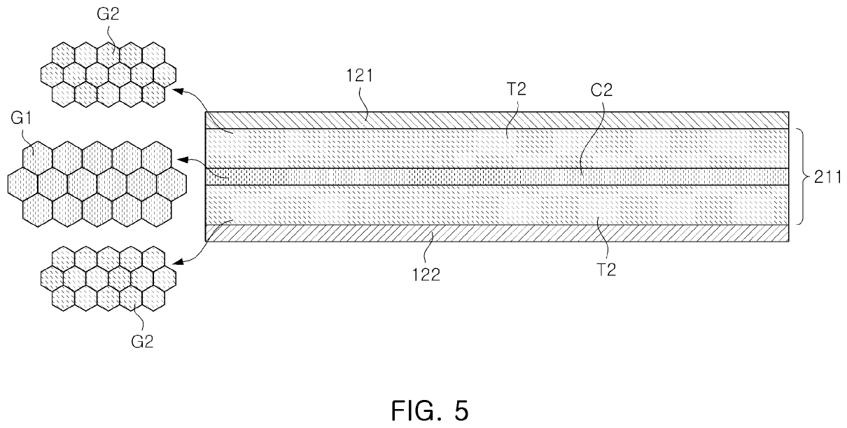

Hereinafter, a multilayer electronic component according to another embodiment of the present disclosure will be described with reference to FIGS. 5 to 8. For configurations identical/similar to those of the multilayer electronic component 100 described in FIGS. 1 to 4, identical/similar reference symbols are used, and duplicate descriptions will be omitted.

FIG. 5 is a cross-sectional view schematically illustrated a microstructure of a dielectric layer 211 of a multilayer electronic component according to another embodiment of the present disclosure.

Referring to FIG. 5, a thickness of an auxiliary layer T2 may be greater than the thickness of the perovskite layer C2. In this case, capacitance of the multilayer electronic component may be somewhat reduced, but excellent reliability and temperature stability may be secured.

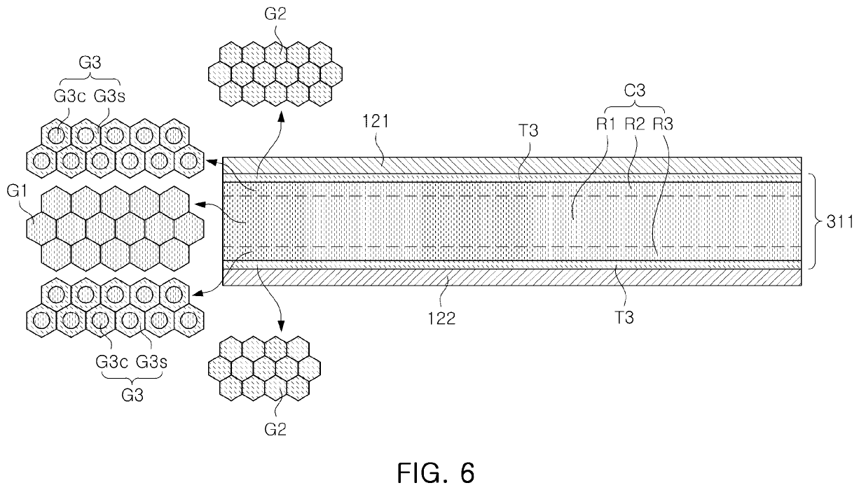

FIG. 6 is a cross-sectional view schematically illustrating a microstructure of a dielectric layer 311 of a multilayer electronic component according to another embodiment of the present disclosure.

Referring to 6, the perovskite layer C3 may include a center region R1 in which a plurality of the first grains G1 may be continuously disposed in a direction perpendicular to the first direction, and an interface regions R2 and R3 having a third grain G3 disposed between the center region R1 and an auxiliary layer T3, and the third grain G3 may have a core-shell structure.

The third grain G3 may include a core portion G3c and a shell portion G3s disposed on at least a portion of the core portion G3c. A concentration of the first additive element in the shell portion G3s may be higher than a concentration of the first additive element in the core portion G3c. The third grain G3 may be formed, for example, by the first additive element diffused from the auxiliary layer T3.

Even in this case, in order to prevent the capacitance of the multilayer electronic component from being reduced, a ratio of the number of first grain G1 to a total number of grains disposed in the perovskite layer C3 may be, for example, 80% or more. The number ratio of the first grain G1 may specify a certain region in an image analyzed by an analysis device such as STEM-EDS of an arbitrary cross-section of the dielectric layer 111 and may be calculated from the total number of grains and the number of the first grains G1 existing in the certain region. The total number of grains extracted from the certain region may be, for example, 10 to 200, but the present disclosure is not limited thereto.

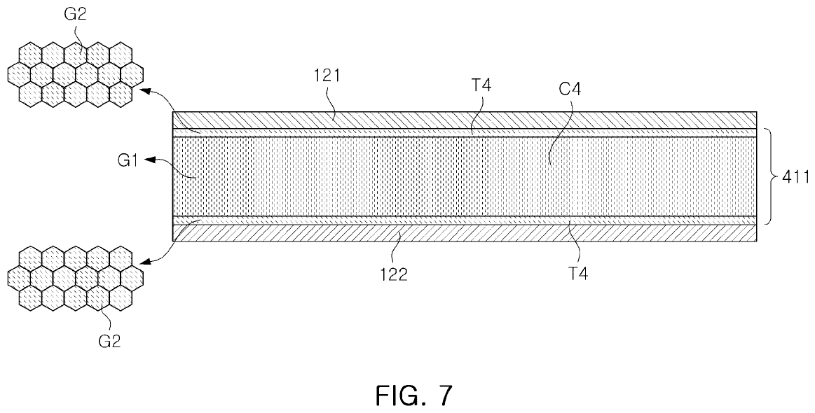

FIG. 7 is a cross-sectional view schematically illustrating a microstructure of a dielectric layer 411 of a multilayer electronic component according to another embodiment of the present disclosure.

Referring to FIG. 7, at least one of the dielectric layers 411 may include a single-crystal perovskite layer C4 including a perovskite compound represented by the general formula ABO₃, and an auxiliary layer T4 disposed on both surfaces of the perovskite layer C4 opposing each other in the first direction and including the first additive element.

The perovskite layer C4 may have a single-crystal structure of the first grain G1. The perovskite layer C4 may be formed, for example, through thin-film synthesis using at least one of CVD, ALD, and sputtering.

As the perovskite layer C4 has a single-crystal structure, sintering of the perovskite layer C4 may become unnecessary. Therefore, the conductive metal to be selected flexible to be included in the internal electrodes 121 and 122 without considering a sintering temperature.

The fact that the perovskite layer C4 has a single-crystal structure may mean an entire perovskite layer C4 has a single-crystal structure. The perovskite layer C4 may contain defects such as cracks or dislocations, but since it has a single-crystal structure, grain boundaries may not exist.

However, not all of a plurality of dielectric layers 411 may have a perovskite layer C4 with a single-crystal structure, and for example, a portion of perovskite layers not having a single-crystal structure may also exist. For example, the number ratio of dielectric layer 411 having a single-crystal structure perovskite layer C4 among a plurality of dielectric layers 411 may be 80% or more.

The auxiliary layer T4 may have, for example, a polycrystalline structure of the second grain G2. The auxiliary layer T4 may secure reliability of the multilayer electronic component by including the first additive element.

The auxiliary layer T4, like the perovskite layer C4, may be formed through thin-film synthesis using at least one of CVD, ALD, and sputtering. In this case, component changes due to mutual diffusion between the perovskite layer C4 and the auxiliary layer T4 may be suppressed.

The auxiliary layer T4 may preferably include, for example, two or more types of first additive elements from the perspective of improving a reliability of the multilayer electronic component. The auxiliary layer T4 may preferably include, for example, two or more second additive elements. When the auxiliary layer T4 includes two or more types of first additive elements and/or two or more types of second additive elements, even if the auxiliary layer T4 is formed by a method such as CVD, ALD, and/or sputtering, the auxiliary layer T4 may have a polycrystalline structure.

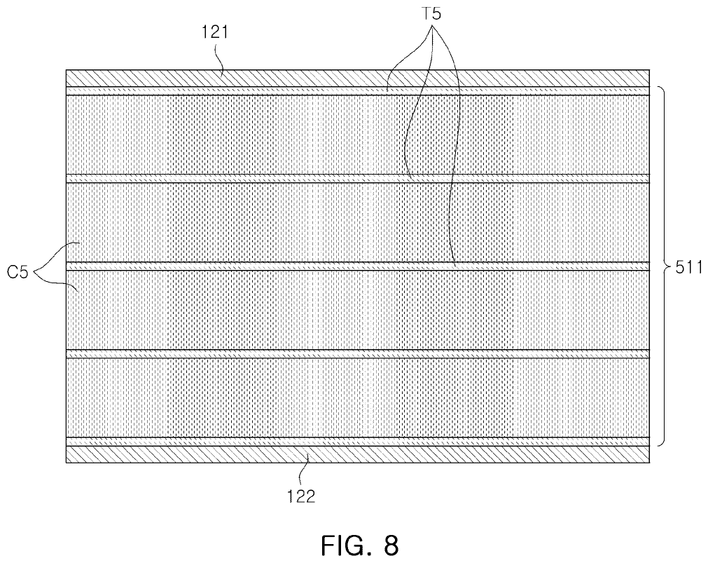

FIG. 8 is a cross-sectional view schematically illustrating a microstructure of a dielectric layer 511 of a multilayer electronic component according to another embodiment of the present disclosure.

Referring to FIG. 8, at least one of the dielectric layers 511 may include a plurality of perovskite layers C5 spaced apart from each other. That is, at least one of the dielectric layers 511 may have a structure in which a plurality of perovskite layers C5 and a plurality of auxiliary layers T5 may be alternately disposed.

In the case of automotive electrical components, it is necessary to form the dielectric layer 511 to have a certain thickness or greater to ensure reliability. In this case, the dielectric layer 511 may include a plurality of perovskite layers C5. The number of perovskite layers C5 included in one dielectric layer 511 is not particularly limited, but considering the purpose or capacitance of the multilayer electronic component, the dielectric layer 511 may include 2 to 50 perovskite layers C5.

Hereinafter, an example of a method for manufacturing a multilayer electronic component 100 will be described. An example of a method for forming a body 110 is described. However, the manufacturing method of the multilayer electronic component 100 is not limited thereto.

First of all, ceramic powder containing a perovskite compound is prepared. The ceramic powder may include, for example, one or more of BaTiO₃, (Ba₁₋ₓCaₓ)TiO₃ (0<x<1), Ba(Ti_{1-y}Ca_{y})O₃ (0<y<1), (Ba₁₋ₓCaₓ)(Ti_{1-y}Zr_{y})O₃ (0<x<1, 0<y<1), Ba(Ti_{1-y}Zr_{y})O₃ (0<y<1), CaZrO₃, and (Ca₁₋ₓSrₓ)(Zr_{1-y}Ti_{y})O₃ (0<x≤0.5, 0<y≤0.5). BaTiO₃ powder may be synthesized, for example, by reacting a titanium raw material such as titanium dioxide with a barium raw material such as barium carbonate. A synthesizing method of the ceramic powder may include methods, for example, a solid phase method, a sol-gel method, a hydrothermal synthesis method, or the like, but the present disclosure may not be limited thereto. Next, the prepared ceramic powder are dried and ground, and then a slurry for producing the perovskite layer is prepared by mixing an organic solvent such as ethanol and a binder such as polyvinyl butyral.

Next, a first additive element powder and a second additive element powder are prepared. The first additive element powder may include, for example, one or more oxides of Dy, Ho, Y, Er, Gd, Tb, Mg, Mn, V, Al, and Si. The second additive element powder may include, for example, one or more oxides of Ba, Ti, Ca, and Zr. The first and second additive element powders, an organic solvent, and a binder are mixed to prepare a slurry for preparing an auxiliary layer.

Next, the slurry for producing the auxiliary layer is applied and dried on a carrier film to form a pre-sintering auxiliary layer, the slurry for producing the perovskite layer is applied and dried on the pre-sintering auxiliary layer to form a pre-sintering perovskite layer, and the slurry for producing the auxiliary layer is reapplied and dried on the pre-sintering perovskite layer to form a pre-sintering auxiliary layer. The pre-sintering perovskite layer and the two pre-sintering auxiliary layers formed on the both surfaces may be defined as a ceramic green sheet.

Next, a conductive paste for an internal electrode containing a metal powder, a binder, an organic solvent, or the like is printed on the ceramic green sheet to a predetermined thickness using a screen printing method or a gravure printing method, thereby forming an internal electrode pattern.

The ceramic green sheet having the internal electrode pattern printed thereon is peeled off from the carrier film, and then the ceramic green sheet having the internal electrode pattern printed in a predetermined amount of layers are laminated and pressed to form a ceramic laminate. On the upper and lower portions of the ceramic laminate, a sheet forming a cover portion without an internal electrode pattern, may be laminated in a predetermined amount of layers to form the cover portion 112 and 113 after sintering. Thereafter, the ceramic laminate is cut to have a predetermined size of chip, and the cut chip is sintered at a temperature of, for example, 1000° C. or higher and 1400° C. or lower to form the body 110.

Next, the external electrodes 131 and 132 are formed. For example, when the base electrode layers 131a and 132a include a sintered electrode layer, the body 110 may be dipped in an external electrode conductive paste including metal powder, glass frit, binder, and an organic solvent, and then the external electrode conductive paste may be sintered at a temperature of 500° C. to 900° C. to form a sintered electrode layer.

For example, when the base electrode layers 131a and 132a include a resin electrode layer, the body may be dipped in a conductive resin composition including metal powder, resin, binder, and organic solvent, followed by curing heat treated at a temperature of 250° C. to 550° C. to form the resin electrode layer.

In addition, an electrolytic plating method and/or an electroless plating method may be additionally performed to form the plating layers 131b and 132b on the base electrode layers 131a and 132a.

Meanwhile, a method of forming dielectric layers 211, 311, 411, and 511 illustrated in FIGS. 5 to 8 is not particularly limited.

For example, the dielectric layer 211 may be manufactured by controlling the amount of the slurry for manufacturing the auxiliary layer and the slurry for manufacturing the perovskite layer so that a thickness of the auxiliary layer T2 becomes greater than a thickness of the perovskite layer C2 after sintering.

For example, the dielectric layer 311 may be manufactured by forming the auxiliary layer T3 using a rare earth element relatively easy to diffuse into the perovskite layer C3 as a first additive element.

For example, the dielectric layer 411 may be manufactured by forming a perovskite layer C4 through thin film synthesis using at least one of CVD, ALD, and sputtering. The auxiliary layer T4 may also be formed through thin film synthesis using at least one of CVD, ALD, and sputtering, but the present disclosure is not limited thereto.

For example, the dielectric layer 511 may be manufactured by alternately performing a process of applying the slurry for manufacturing the auxiliary layer and a process of applying the slurry for manufacturing the perovskite layer a plurality of times.

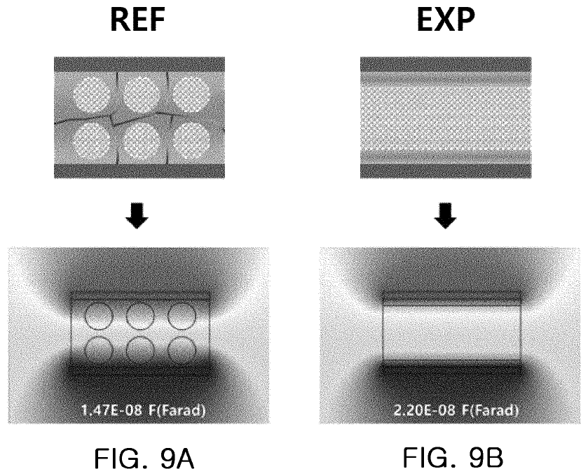

FIGS. 9A and 9B are each a drawing illustrating capacitance of comparative examples and embodiments, respectively, measured using a COMSOL analysis program.

In FIG. 9B, the example EXP represents a dielectric layer having a perovskite layer and an auxiliary layer, and in FIG. 9A, the comparative example REF represents a dielectric layer having grains of a conventional core-shell structure.

Referring to FIGS. 9A and 9B, it may be confirmed that the capacitance of the example increases by about 50% compared to the comparative example when a thickness of the dielectric layer is the same. This is because, in the case of the comparative example, it is difficult to sufficiently secure the area of the core among a core-shell structure, but in the case of the example, the area of the perovskite layer contributing to capacitance formation may be sufficiently secured by forming the perovskite layer and the auxiliary layer separately.

The present disclosure is not limit the above-described embodiments and the accompanying drawings but is defined by the appended claims. Therefore, those of ordinary skill in the art may make various replacements, modifications, or changes without departing from the scope of the present disclosure defined by the appended claims, and these replacements, modifications, or changes should be construed as being included in the scope of the present disclosure.

In addition, the expression ‘an example embodiment’ does not mean the same embodiment, and is provided to emphasize and explain different unique characteristics. However, the embodiments presented above do not preclude being implemented in combination with the features of another embodiment. For example, although items described in a specific embodiment are not described in another embodiment, the items may be understood as a description related to another embodiment unless a description opposite or contradictory to the items is in another embodiment.

In the present disclosure, the term “connected” includes not only direct connection but also indirect connection through an adhesive layer or the like. Additionally, the term electrically connected includes both physically connected and not physically connected. The terms “first,” “second,” and the like may be used to distinguish one element from another, and may not limit a sequence and/or an importance, or others, in relation to the elements. In some cases, a first element may be referred to as a second element, and similarly, a second element may be referred to as a first element without departing from the scope of right of the example embodiments.

As one of the various effects of the present disclosure, a multilayer electronic component with excellent reliability can be provided.

While the embodiments have been illustrated and described above, it will be configured as apparent to those skilled in the art that modifications and variations could be made without departing from the scope of the present disclosure as defined by the appended claims.

What is claimed is:

1. A multilayer electronic component comprising:
a body including dielectric layers and internal electrodes alternately disposed with at least one of the dielectric layers in a first direction; and
an external electrode disposed on the body and connected to at least one of the internal electrodes;
wherein the at least one of the dielectric layers includes:
a perovskite layer including a first grain free of a core-shell structure and comprising a perovskite compound represented by a general formula ABO₃, and
an auxiliary layer disposed on both surfaces of the perovskite layer opposing in the first direction and including a first additive element,
the first additive element includes at least one selected from Dy, Ho, Y, Er, Gd, Tb, Mg, Mn, V, Al, and Si.

2. The multilayer electronic component of claim 1,
wherein the perovskite layer includes a plurality of first grains disposed continuously in a direction perpendicular to the first direction.

3. The multilayer electronic component of claim 1,
wherein the first grain substantially does not contain the first additive element.

4. The multilayer electronic component of claim 1,
wherein the auxiliary layer further includes a second additive element including at least one selected from Ba, Ti, Ca and Zr.

5. The multilayer electronic component of claim 1, wherein a thickness of the perovskite layer is greater than a thickness of the auxiliary layer.

6. The multilayer electronic component of claim 1, wherein a thickness of the auxiliary layer is greater than a thickness of the perovskite layer.

7. The multilayer electronic component of claim 2, wherein the perovskite layer includes:
a center region in which the plurality of first grains is continuously disposed in the direction perpendicular to the first direction, and
an interface region disposed between the center region and the auxiliary layer and having a third grain,
wherein the third grain has the core-shell structure.

8. The multilayer electronic component of claim 1, wherein the perovskite layer has a single-crystal structure of the first grain.

9. The multilayer electronic component of claim 8, wherein the auxiliary layer includes a second grain, and the auxiliary layer has a polycrystalline structure of the second grain.

10. The multilayer electronic component of claim 1, wherein the perovskite layer includes a plurality of perovskite layers spaced apart from each other.

11. The multilayer electronic component of claim 1, wherein the perovskite layer is in a form of a single crystal.

12. The multilayer electronic component of claim 1, wherein the perovskite layer includes a third grain, and the third grain includes the first additive element.

13. The multilayer electronic component of claim 10, wherein the auxiliary layer includes a plurality of auxiliary layers spaced apart from each other, and one or more auxiliary layers among the plurality of auxiliary layers interpose adjacent perovskite layers among the plurality of perovskite layers.

14. A multilayer electronic component comprising:
a body including dielectric layers and internal electrodes alternately disposed with at least one of the dielectric layers in a first direction; and
an external electrode disposed on the body and connected to at least one of the internal electrodes;
wherein the at least one of the dielectric layers includes:
a single-crystal perovskite layer including a perovskite compound represented by a general formula ABO₃, and
an auxiliary layer disposed on both surfaces of the single-crystal perovskite layer opposing in the first direction and including a first additive element.

15. The multilayer electronic component of claim 14, wherein the first additive element includes at least one selected from Dy, Ho, Y, Er, Gd, Tb, Mg, Mn, V, Al, and Si.

16. The multilayer electronic component of claim 14, wherein the auxiliary layer has a polycrystalline structure.

17. The multilayer electronic component of claim 14, wherein the auxiliary layer further includes a second additive element including at least one selected from Ba, Ti, Ca and Zr.
